(19) United States
(12) Patent Application Publication
(10) Pub. No.: US 2013/0094657 A1
(43) Pub. Date: Apr. 18, 2013

(54) METHOD AND DEVICE FOR IMPROVING THE AUDIBILITY, LOCALIZATION AND INTELLIGIBILITY OF SOUNDS, AND COMFORT OF COMMUNICATION DEVICES WORN ON OR IN THE EAR

(71) Applicant: UNIVERSITY OF CONNECTICUT, Farmington, CT (US)

(72) Inventors: Anthony John BRAMMER, Ottawa (CA); Eric Raczka Bernstein, Windsor, CT (US)

(73) Assignee: UNIVERSITY OF CONNECTICUT, Farmington, CT (US)

(21) Appl. No.: 13/650,517

(22) Filed: Oct. 12, 2012

Related U.S. Application Data
(60) Provisional application No. 61/546,555, filed on Oct. 12, 2011.

(51) Int. Cl. G10K 11/16

(52) U.S. Cl. 381/71.6

(57) ABSTRACT

A method and device are provided for maintaining or improving the audibility, localization and/or intelligibility of sounds from electro-acoustic devices worn on the head or in the ear, such as headphones, headsets, hearing protectors, earplugs, and earbuds, as well as in combination with or built into hard hats and helmets, and for improving their comfort to the user.

### CROSS-REFERENCE TO RELATED APPLICATIONS

This application claims the benefit of U.S. Provisional Application No. 61/546,555, filed Oct. 12, 2011.

### STATEMENT REGARDING FEDERALLY SPONSORED RESEARCH OR DEVELOPMENT

This invention was made with government support under Contract R01 OH008669 awarded by the National Institute for Occupational Safety and Health (NIOSH). The government has certain rights in the invention.

### BACKGROUND OF THE DISCLOSURE

1. Field of Disclosure

This disclosure relates to the fields of audible communication and hearing protection, and in particular to enhancing the audibility, localization or intelligibility of sounds produced by electro-acoustic devices worn on or in the ear, such as earphones, headphones, headsets and hearing protectors, as well as in combination with hard hats and helmets, and the comfort of such devices.

2. Description of Related Art

Improving the audibility, or intelligibility, of sounds by means of electro-acoustic devices such as earphones, headphones, headsets and hearing protectors has been an objective for many years. In many situations, the sound that is desired to be heard is rendered inaudible, or unintelligible, by competing sounds or attenuation between the sound source and the observer. In these circumstances an electro-acoustic device may be introduced to mediate the relative strengths of the desired and undesired sound fields at the observer. The role of the device is to suppress the undesired sound field and/or enhance the desired sound field at the observer. To achieve these objectives, the device must sense the sound fields, process one or both of them electronically, and return a representation of the desired sound field to the observer.

As used in this application, active control means suppressing the undesired sound field and/or enhancing the desired sound field at the observer or user of the device. A controller, which is a means to effect control, must sense the sound fields, process one or more of them, and return a representation of the sound fields to the observer. As an example, active control of an unwanted environmental noise can mean, in some situations, features that reduce the unwanted environmental noise, but can also mean, in other situations, features that amplify the unwanted environmental noise, where such amplification is desirable. Both are examples of active control, as used herein.

As used in this application, ear cover means any device that covers or surrounds all or a portion of the ear, including, but not limited to, ear muffs, earphones, headphones, headsets, hearing protectors, hard hats with coverings that protect the ear, and helmets with coverings that protect the ear.

The suppression of unwanted sounds or unwanted acoustic noise, such as environmental, industrial or military noise, music or speech babble, has been sought for many years, and active electro-acoustic systems have been developed for this purpose. Recent advances in electronics and dedicated microcomputers (e.g., digital signal processors—“DSPs”) have led to a resurgence of interest in devices containing microphones, earphones and electronics to aid communication and “situational awareness” (i.e., rendering audible warning sounds, localizing sounds, and maintaining “contact” with the environment) (Brammer et al., 2008; Alali and Casali, 2011; Giguère et al., 2011). A common assumption is that the intrinsic passive attenuation of a device worn on the head or in the ear can provide excessive attenuation of environmental noise, and so sounds can be safely amplified above the ambient noise recorded at the ear in these circumstances. Devices that amplify sounds reaching the ear depending on the sound level can, in principle, be effective when the combination of the residual unwanted sounds and the reproduced desired sounds at the ear remains below limits established for hearing conservation. To our knowledge, there is as yet no device sufficiently engineered to restore reliably the situational awareness to that in the absence of the device. In the case of hearing protectors, even when so-called sound-level dependent hearing protectors have been found to improve situational awareness, these were rated lower than traditional hearing protectors in usability and comfort (Tufts et al., 2011).

Other devices focus on control of unwanted sounds, such as environmental, industrial or military noise, music or speech babble, and employ adaptive digital active noise control to reduce the noise at the ear below that provided by the conventional passive attenuation of a device worn on the head or in the ear. The essential differences between a device equipped with a sound-level dependent electro-acoustic system and one with an active noise control system can be seen from the simplified block diagrams in FIG. 1, which represent prior art. In these examples, an ear cover and cushion are shown in cross section with the head being to the right of the diagram. A device would usually consist of identical or mirror image covers for each ear. Thick lines depict environmental noise signal paths and dashed lines depict communication signal paths.

The level-dependent device employs one or more microphones to sense the unwanted sounds (e.g., environmental noise) and one or more microphones to sense the sounds at the ear, termed the reference (R) and error (E) microphones, respectively, as shown in FIG. 1C. A small so-called secondary sound source, here an earphone, S, is used to reproduce sounds at the ear. When the device is used for hearing protection, environmental sounds sensed by microphone R are amplified and then fed to the earphone S, to improve the audibility of sounds external to the device, provided the sound level at E is below the limit established for hearing conservation. A requirement common to many devices is thus to employ the signal from the error microphone to compute the noise exposure at the ear (i.e., calculated from the product of the sound level and time of exposure). In simple level-dependent devices, all sounds are amplified usually with a preference for frequencies in which speech sounds are to be expected (e.g., frequencies greater the 125 Hz). This frequency- and sound level-dependent processing can improve audibility for unwanted sounds (e.g., environmental, industrial or military noise) that decrease in intensity with increasing frequency. In commercial devices, the processing may involve analog or digital electronics. Some devices preferentially amplify sounds in front of the observer but in doing so render the listener less aware of sounds that are behind them (Giguère et al., 2011). Many level-dependent devices are equipped with a communication channel: this signal is also fed to the earphone (shown by dashed lines in FIG. 1, with the Σ⁺ indicating the summation of signals).

A feedforward active noise control device employs, in principle, the same electro-acoustic components as a level-dependent device. The block diagram in FIG. 1B has been drawn to illustrate the similarities and differences to the concept in FIG. 1C. The variable gain amplifier of FIG. 1C is replaced by an adjustable filter that controls the intensity of unwanted sounds sensed by microphone R. The control system accounts for the transmission of sound from R to E, by using microphone E to sense the residual sound at the ear. As before, the signal from the error microphone may be used to compute the noise exposure at the ear. In practical applications, sound cancellation is implemented digitally by an adaptive filter, the coefficients of which are calculated by an algorithm—commonly the so-called Filtered-X Least Mean Squares algorithm (LMS). The algorithm is most effective when it includes a model (i.e., filter) to represent the transmission of sound from S to E, which is termed the error path model (see FIG. 1B). However, in contrast to the level-dependent device of FIG. 1C, the time available for processing the unwanted sound cannot exceed the time taken for it to propagate from R to S, which for a device mounted on or at the ear is typically ˜150 μs. This constraint to the processing time ultimately limits the complexity of algorithms that may be employed and led to devices such as those patented by Pan and Brammer (1998). Within this limitation, unwanted sounds, such as environmental, industrial or military noise, music or speech babble, may be reduced at frequencies below ˜800 Hz. These are precisely the frequencies at which ear covers produce least sound attenuation for the user.

A feedback active noise control system, operating from ˜800 Hz to ˜1600 Hz, can be introduced to augment this improvement (FIG. 1A). Feedback active noise control systems are more commonly designed to operate over a broader frequency range (e.g., 80-800 Hz) with a corresponding reduction in the active noise reduction (which is related to bandwidth through the requirement to maintain stability). Combining feedforward and feedback active noise control systems has been reported to improve the stability of each and result in so-called hybrid systems (Ray et al, 2006; Ray and Streeter, 2006). The combinations may be used to advantage for specific applications. The basic control systems are described in more detail in the references cited and in books by, for example, Nelson and Elliot, Active Control of Sound, published by Academic Press, London (1992), Kuo and Morgan, Active Noise Control Systems: Algorithms and DSP Implementations, published by Wiley, New York (1996), and Elliot, Signal Processing for Active Control, published by Academic Press, London (2002).

Limitations to the performance of these devices are caused by time-varying changes in the error path, such as occur when an ear cover is displaced with respect to the ear or an earplug/earbud does not form a seal to the ear canal, and when the intensity of the sounds being controlled changes substantially. There are two primary methods whereby the error-path transfer function may be established. The first involves measuring the transfer function, such as described by Brammer and Pan (1999), and the second involves modeling the transfer function, such as described in the book by Kuo and Morgan. For time-varying systems, one approach is to model the error-path transfer function while the device is operating, such as described by Erikkson (1987) and more generally by Kuo and Morgan. The method may involve introducing a test signal that is minimized by an adaptive filter, the coefficients of which then represent the error path transfer function. For small variations in error path transfer function it may be sufficient to approximate the impulse response by synthesizing the transfer function or truncating a measured transfer function, such as described in patents by Pan and Brammer (1998) and Brammer and Pan (2003).

Many devices with active noise control systems are also equipped with a communication channel: this signal is fed to the secondary source or earphone in FIG. 1 (shown by dashed lines, with the Σ⁺ indicating the summation of signals). A second miniature earphone or loudspeaker may be dedicated to reproducing the communication signal (not shown in FIG. 1). The communication signal sensed at microphone E needs to be removed from the control signal if a feedback control structure is employed. This is achieved by subtracting the communication signal from the control signal after the former is passed through an error path model filter (also dashed lines in FIG. 1A, with Σ⁻ indicating the subtraction of the signals). A similar concept may be applied to remove the communication signal from the error signal if a feedforward control structure is employed (not shown in FIG. 1) but is not essential as the signals from the reference and error microphones are uncorrelated (Brammer et al., 2003, 2005).

A common complaint of users of ear covers or devices worn in the ear is discomfort from uneven pressure on the skin around the ear or, for devices in the ear, within the ear canal. Another common complaint is perspiration where the skin contacts the device. Both of these complaints discourage long-term use of many conventional devices.

### SUMMARY OF THE DISCLOSURE

The present disclosure provides a method and device for maintaining or improving the audibility, localization and/or intelligibility of sounds from electro-acoustic devices worn on or in the ear, such as ear covers, earplugs, and earbuds, as well as in combination with or built into hard hats and helmets, and improving their comfort to the user.

The present disclosure also applies delayless subband processing to electro-acoustic devices worn on or in the ear, such as ear covers, earplugs, and earbuds, as well as in combination with, or built into, hard hats and helmets.

The present disclosure further provides a method and device to reduce user discomfort when wearing ear covers on the head or devices in the ear, by reducing pressure variations on the skin, and by introducing air ventilation paths to the ear and/or within the ear canal.

### BRIEF DESCRIPTION OF THE DRAWINGS

FIGS. 1A, 1B and 1C (Prior Art) are block diagrams of the prior art illustrating the following: FIG. 1A—feedback; FIG. 1B—feedforward active noise controllers; and FIG. 1C—level-dependent processors, shown attached to circumaural ear muffs. As noted above, in these diagrams, thick lines depict acoustic noise signal paths, thin lines depict control signal paths, and dashed lines depict communication signal paths.

FIG. 2 is a diagram illustrating an exemplary embodiment of the present disclosure, with an ear cover providing multi-band (subband), frequency-dependent amplification without or without compression of the communication signal, and sound pressure monitoring.

FIG. 3 is a diagram that illustrates an exemplary embodiment of the implementation of subband, frequency-dependent amplification with power monitoring, signal-to-noise ratio selection, and gain optimization.

FIG. 4 is a diagram that illustrates a delayless subband implementation of FIG. 2 for a communication signal.

FIG. 5 is a diagram that illustrates an ear cover that does not involve an air seal around the ear in which unwanted acoustic noise is reduced by an adaptive noise controller at the ear of the user, where the error microphone is preferably positioned within the concha at the entrance to the ear canal.

FIG. 6 is a diagram that illustrates a device similar to that in FIG. 5, but with feedback control of environmental noise and an error microphone mounted at the earphone.

FIG. 7 is a diagram that illustrates an ear cover that includes an air seal around the ear with independent adaptive digital active noise controllers with a separate communication channel.

FIG. 8 is a diagram that illustrates an ear cover that includes an air seal around the ear with independent adaptive digital active noise controllers and separate communication channel, optimized to operate over an extended range of sound pressures by means of adjustable amplifier gains G_{mic} on the reference and error signal paths, and Gₛₛ on the secondary source signal path.

FIG. 9 is a diagram that illustrates an ear cover with independent adaptive digital active noise controllers and separate communication channel, optimized for operation when there is an air leak permitting air circulation under the ear cup, and sound to feed back from the earphone to the reference microphone.

FIG. 10 is a diagram that illustrates an ear cover that includes an air seal around the ear with feedforward subband active noise control system shown to the left of the diagram, and a subband communication signal processor shown to the right.

FIG. 11 is a diagram that illustrates an earplug with a feedforward subband active noise control system, shown to the left of the diagram, and a subband communication signal processor, shown to the right.

FIG. 12 is a diagram that illustrates an ear cover that does not involve an air seal around the ear with feedforward subband active noise control system, shown to the left of the diagram, and a subband communication signal processor, shown to the right.

FIG. 13 is a diagram that illustrates an ear cover that includes an air seal around the ear and earplug configured to produce substantial attenuation of unwanted acoustic noise in the ear canal, where a subband active noise controller is applied to the ear cover and combined with a subband communication controller applied to the earplug.

FIG. 14 is a diagram that illustrates an ear cover that includes an air seal around the ear and earplug configured to produce substantial attenuation of unwanted acoustic noise in the ear canal, where a subband active noise controller is applied to the ear cover, followed by a second subband active noise controller combined with a subband communication controller applied to the earplug.

### DETAILED DESCRIPTION OF THE DISCLOSURE

The present disclosure provides a method and device for improving the audibility, localization, and speech intelligibility of communication devices worn on the head or in the ear for persons with normal hearing as well as hearing loss.

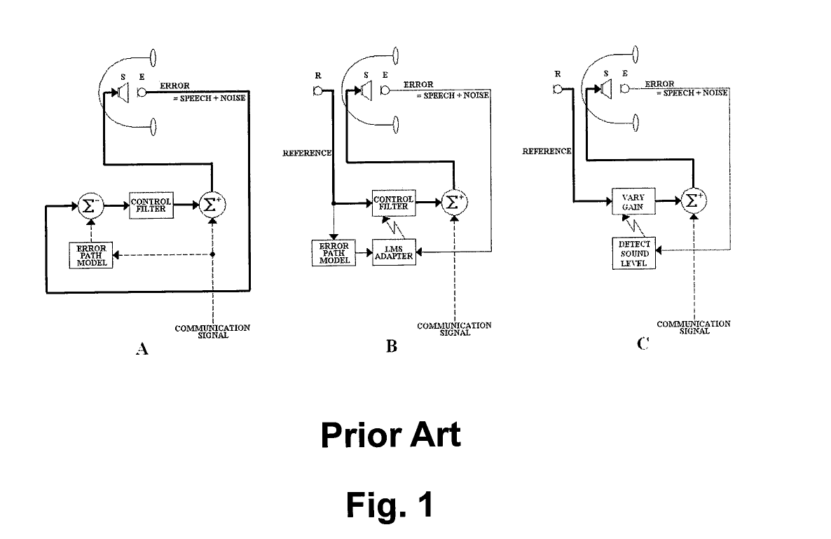

Enhancing the communication signal may take many forms. When the goal is improved audibility of sounds, the electronic amplification of the communication signal may be increased, to improve the signal-to-noise ratio (S/N). This strategy is often used when the communication signal can be distinguished from any competing sounds, such as when a separate communication channel is employed, as shown in FIG. 1. The communication channel may contain signals from one or more sensors arranged to enhance nearby desired sounds, such as a directional microphone or array of microphones (i.e., “beamformer”), or from a remote talker via an electronic link.

When the goal is improved response to warning sounds, the device must combine audibility with the direction of the warning sound with respect to the observer. This may require constructing a sound field at the ear that mimics the directional information and may involve presenting the enhanced sounds binaurally to reproduce inter-aural time and frequency differences.

Localization can be aided by shaping the exterior of an ear cover to introduce some of the frequency selective characteristics of structures forming the external ear (e.g., pinna, concha), which influence front-back confusions.

When the goal is to improve the intelligibility of speech, the performance will depend not only on the relative strengths of the speech and competing sounds, as expressed by the speech signal-to-“noise” ratio (speech S/N), but also on the distortion introduced by the communication system and the clarity and pronunciation of the talker. Effective improvement of the speech S/N may involve either increasing the speech signal or reducing the unwanted sound or “noise,” or both.

When the goal is to assist speech intelligibility for persons who experience degraded understanding from hearing loss, the device will be based on strategies for improving the audition of persons by applying frequency-dependent amplification and amplitude compression.

Advanced control systems may employ signal processing involving simultaneous, parallel processing of separate frequency bands of signals (so-called subband processing) as described in the book by Lee, Can and Kuo, Subband Adaptive Filtering, published by Wiley, New York (2009). In effect, the single noise controller of FIG. 1A or B is replaced by many such controllers connected in parallel, each operating independently over a different frequency range. The intention of subband processing is to maintain or improve filter performance compared to the equivalent fullband filter (i.e., the filter bandwidth comprising the total frequency range of all subband filters) with less computational complexity, which has already been noted to be a critical factor for the present application of DSPs. The present disclosure applies delayless subband processing to electro-acoustic devices worn on or in the ear, such as ear covers, earplugs, and earbuds, as well as in combination with or built into hard hats and helmets.

As noted above, a common complaint of users of communication devices worn on the head or in the ear is discomfort from uneven pressure on the skin around the ear or, for devices in the ear, within the ear canal. Another common complaint by users is perspiration where the skin contacts the communication device. These concerns discourage long-term use of many devices. The present disclosure provides a method and device that reduce discomfort to users by reducing pressure variations on the skin, and by introducing air ventilation paths to the ear and/or within the ear canal.

The method and device of the present disclosure is applicable to the active electronic control of sounds from one or more sources. It is applicable to analog and digital controllers, and to SISO (single input single output), to MISO (multiple input single output), and to MIMO (multiple input multiple output) control systems. It is applicable to feedforward, feedback and hybrid methods of control, and to systems that contain fixed control filters or filters that are adjustable in time in order to improve or optimize performance according to one or more separately determined performance criteria.

The present disclosure provides for one or more of the following: a method and device for active feedforward control, and/or for active feedback control, or for both active feedforward and feedback control, of sound and of unwanted acoustic noise.

The present disclosure also provides one or more method and device for active control of the amplitude and/or frequency of the desired sound and/or acoustic noise, including amplitude compression and frequency selection.

One or more of the above-disclosed methods and devices may also be combined with one or more of the following methods and devices.

The present disclosure provides a method and device for multi-rate processing of signals to reduce the time delay of data acquisition and/or reduce the number of filter coefficients required to encompass the frequency bands of the sound or unwanted acoustic noise.

The present disclosure also provides a method and device for fullband or subband processing of unwanted acoustic noise, for fullband or subband processing of the desired sounds, or for fullband or subband processing of both unwanted acoustic noise and desired sounds.

The present disclosure further provides a method and device for processing both unwanted acoustic noise and desired sounds using identical fullbands and/or by using identical subbands.

The present disclosure still further provides a method and device for sensing and/or processing unwanted acoustic noise and/or desired sounds to improve the audibility of the desired sounds, and to improve the localization of the desired sounds.

The present disclosure also provides a method and device for sensing and/or processing unwanted acoustic noise and/or desired sounds to improve the localization of the desired sounds such as by binaural processing of sounds sensed and reproduced at the two ears, and/or by employing multiple microphones on an ear cover, hard hat or helmet.

Still further, the present disclosure provides a method and device for sensing and/or processing unwanted acoustic noise and/or desired sounds to improve the localization of the desired sounds such as by frequency shaping to simulate the characteristics of the ear, and/or by shaping the exterior of an ear cover to introduce some or all of the frequency-selective characteristics of the structures forming the external ear (e.g., pinna and/or concha).

The present disclosure also provides a method and device for processing unwanted acoustic noise and/or desired sounds to improve the intelligibility of speech, according to a prescribed metric of speech intelligibility such as the Speech Intelligibility Index or the Speech Transmission Index.

The present disclosure further provides a method and device for processing unwanted acoustic noise and/or desired sounds to improve the audibility, localization and/or intelligibility of speech for persons with hearing loss, such as by employing frequency-dependent amplification determined by their audiometric hearing thresholds, and/or by employing frequency-dependent and sound pressure-dependent amplification.

The present disclosure yet further provides a method and device for improving audibility and/or localization and/or speech intelligibility by employing one, or more, directional microphones or array of microphones (such as a “beamformer”).

The present disclosure also provides a method and device for improving audibility and/or localization and/or speech intelligibility while maintaining the sound levels at the ear within preset limits, so as to protect hearing, and/or while maintaining the S/N and/or speech S/N at the ear within preset limits.

The present disclosure further provides a method and device for measuring the error path transfer function, or functions if there are more than one earphone and/or error microphone, of a system used to control sound and/or unwanted acoustic noise.

The present disclosure yet further provides a method and device for modeling the error path transfer function, or functions if there are more than one earphone and/or error microphone, of a system used to control sound and/or unwanted acoustic noise.

In addition, the present disclosure provides a method and device for synthesizing or truncating the error path transfer function, or functions if there are more than one earphone and/or error microphone, of a system used to control sound and/or unwanted acoustic noise.

The present disclosure also provides a method and device for determining an error path transfer function, or functions if there are more than one earphone and/or error microphone, of a system used to control sound and/or unwanted acoustic noise while the control system is operating.

The present disclosure further provides a method and device for sampling the desired sound at a different sampling frequency from the unwanted acoustic noise. The desired sound can be sampled at a higher frequency than the unwanted acoustic noise. The desired sound can be processed at a different frequency than the unwanted acoustic noise.

The present disclosure still further provides a method and device for accommodating a large dynamic range of unwanted acoustic noise by introducing leakage as described by Kuo and Morgan or otherwise restricting filter adaptation at small or large signal magnitudes.

The present disclosure also provides a method and device for varying the gains of the paths of the reference signal, or signals if there is more than one reference microphone, the control signal, or signals if there is more than one secondary source for reproducing sound at the output of the control system, and the error signal, or signals if there is more than one error microphone, so that the error path transfer function response, or functions if there are more than one secondary source and/or error microphone, remain unchanged.

The present disclosure further provides a method and device for sensing the sound pressure at the eardrum such as by positioning a microphone within the concha at the entrance to the ear canal.

The present disclosure still further provides a method and device for compensating for changes in the error path transfer function, or functions if there are more than one earphone and/or error microphone, by employing an adaptive filter, and/or by employing one or more adaptive subband filters.

The present disclosure also provides a method and device for compensating for an air leak in the seal between the device and the skin around or in the ear, by employing one or more adaptive filters or subband filters of an active noise controller.

The present disclosure further provides a method and device for reproducing sound at the output or outputs of the control system.

The present disclosure still further provides a method and device for reproducing the contours of the head or ear canal on the device to equalize contact pressure and improve comfort of the user.

The present disclosure yet further provides a method and device for combining an ear cover and earplug to provide double protection of the user from unwanted acoustic noise.

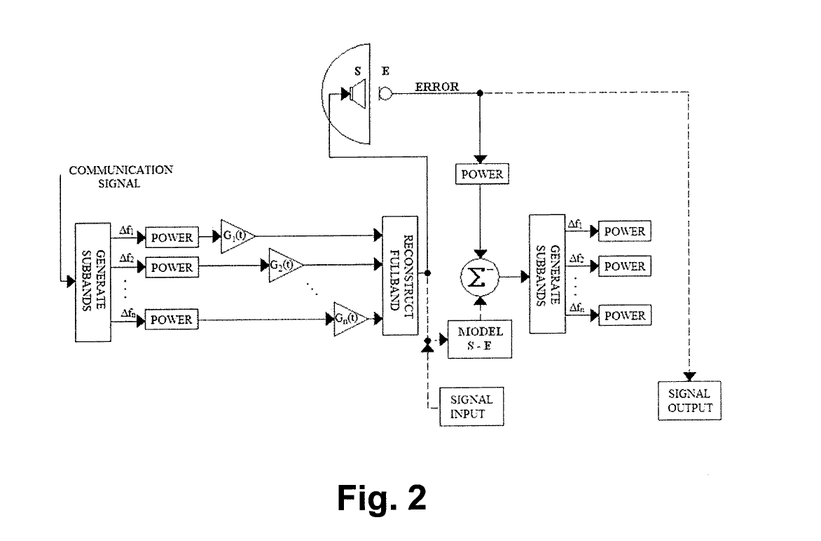

Referring now to the drawings, and in particular, FIG. 2, there is provided a block diagram that illustrates a preferred exemplary embodiment of the present disclosure. The device, shown for one ear as part of an ear cover that does not involve an air seal around the ear, consists of one or more dedicated or shared controllers and one or more electroacoustic devices to generate sound, such as an earphone or earphones, and sense sound, such as a microphone or microphones. The controller(s) may include low-pass, high-pass, or band-pass filters using analog electrical, acoustical and/or electroacoustic devices, analog/digital (A/D) and digital/analog (D/A) converters, amplifiers and one or more DSPs.

The device employs multi-band amplification and compression of the communication signal, indicated by n subbands generated with bandwidths Δf₁, Δf₂, Δf₃, . . . Δfₙ, and the gain blocks, G₁(t), G₂(t), G₃(t), . . . Gₙ(t), with interconnections shown by dashed lines, to produce frequency-dependent gain. It may also produce level-dependent gain. The individual subband gains, which may differ substantially, may then be further processed by a procedure involving partial or full averaging across subbands or other methods to reduce the artificiality of sounds.

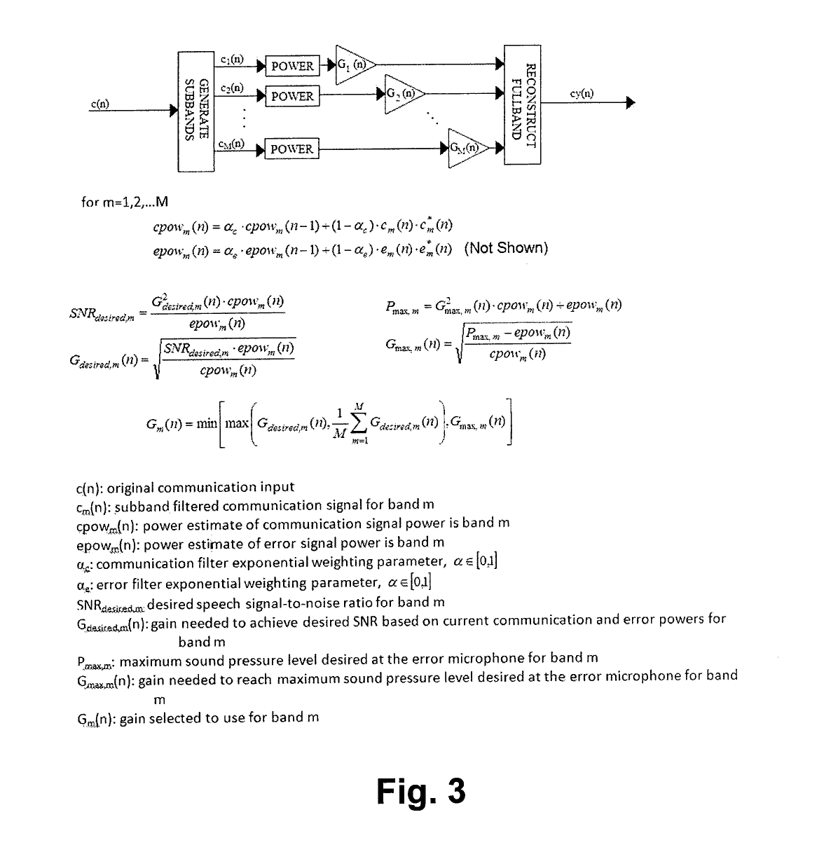

FIG. 3 is a block diagram with mathematical equations illustrating one implementation of the method and device of the present disclosure.

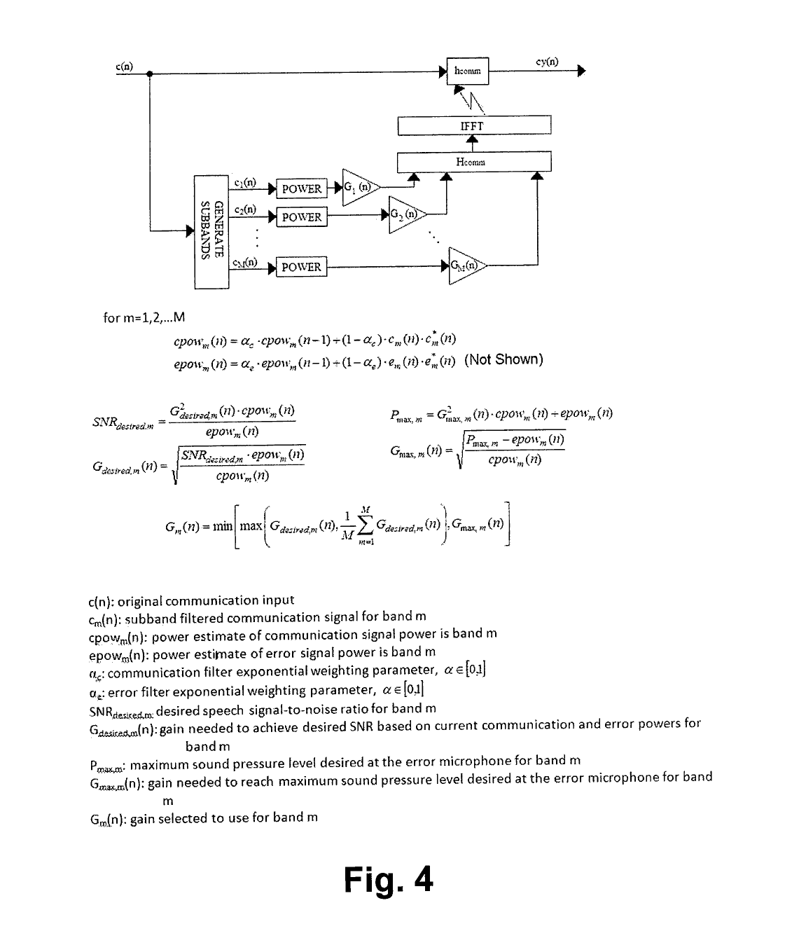

FIG. 4 is a block diagram with mathematical equations illustrating a delayless subband implementation of the method and device of the present disclosure. The device is intended to provide users with normal hearing and persons with hearing loss with optimized gain for speech understanding and music, and to protect them from exposure to high sound pressure levels (SPLs) at the ear. For persons with hearing loss, the goal is also to produce frequency-dependent and level-dependent gain that is customized to the needs of the user based on their hearing loss, which may be characterized, for example, by audiometric hearing thresholds. The device algorithm may include compensating for the increased speech-to-noise ratio required by most persons with hearing loss while maintaining an overall comfortable listening SPL at the ear ˜65-70 dBA, and compensating for the reduction in speech intelligibility occurring at high SPLs.

In related work, we have shown that the sound pressures at locations 1-5 cm from the entrance to the ear canal display reduced coherence at high frequencies with increasing distance from the eardrum. Coherence is maintained from the eardrum to the entrance to the ear canal for sounds at frequencies up to at least 8 kHz.

Since the exact position of the ear cover relative to the entrance to the ear canal will change somewhat each time the device is worn, the present disclosure provides a microphone positioned at the entrance to the ear canal, as shown in FIG. 2 (microphone E). One purpose of this microphone is to ensure that the sounds reproduced at the earphone, S, are monitored at the entrance to the ear canal, and hence reach the eardrum. The sound pressure levels at the entrance to the ear canal and within each subband are continuously monitored (shown by blocks labeled “power”). The power of the communication signal is determined within each subband before amplification, and after amplification over the full bandwidth at the entrance to the ear canal, to ensure that the sound pressure level at the ear is within an acceptable range for audibility and hearing conservation. Any volume control provided for the user to adjust the communication signal intensity (not shown in FIG. 2) is also subject to power monitoring and control as shown in the diagram. The communication signal is also removed from the signal derived from the error microphone (dashed signal path), by filtering it with the transfer function from the earphone to the error microphone (shown as “model S-E,” or the error path model, and the Σ⁻ in FIG. 2). The methods and devices for measuring or modeling the error path transfer function may involve a signal input and signal output as shown in FIG. 2. The signal generation device that provides the signal input may produce sound that is uncorrelated with the unwanted acoustic noise. The signal input may consist of a swept pure tone, or pseudo-random noise, including a multiple length sequence (MLS), or a combination of such signals. A calculation device, such as a digital controller or DSP, produces an estimate of the error path transfer function from the signal input and signal output, such as by cross correlating these signals to obtain the impulse response. In this way, the noise power can be determined in each subband and appropriate signal-to-noise ratios established in each subband for communication and hearing conservation. Alternatively, this device could equally be constructed to fit within the ear as an earbud or earphone.

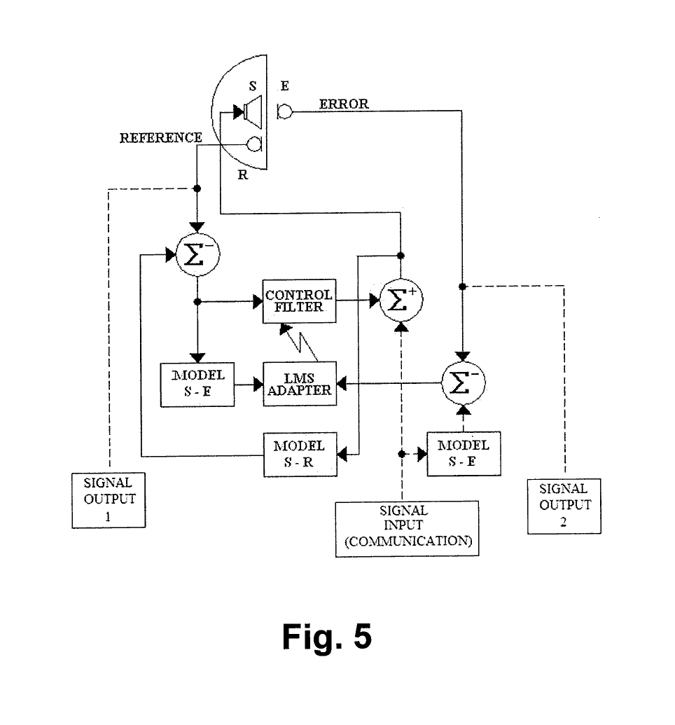

FIG. 5 is a block diagram that illustrates another preferred embodiment of the present disclosure. This device is shown as an ear cover that does not involve an air seal around the ear but could equally be constructed to fit within the ear as an earbud. In this embodiment the unwanted acoustic noise at the ear of the user (as opposed to at the microphone near the mouth of the user, as done in some commercial devices) is reduced, since reductions in speech intelligibility are commonly experienced in the presence of environmental noise or competing talkers (i.e., speech “babble”). This is achieved by using the adaptive control system with block diagram shown in FIG. 3. The signal fed to the control filter is obtained from the reference microphone (R), which is in close proximity to the earphone. Before entering the control system the output from the secondary source or earphone, S, is removed from this signal. To achieve this, the transfer function from the earphone output to the reference microphone is modeled, shown as “model S-R”, and subtracted from the reference signal. The control filter is adapted by employing an algorithm that computes the least mean squared (LMS) error for the (digital) filter coefficients. The algorithm may include magnitude or power normalization, leakage or otherwise restrict filter adaptation at small or large sound pressures to improve the stability of adaptation and/or extend the range of sound pressures that can be successfully controlled.

In the embodiment shown, the control system minimizes the unwanted acoustic noise at the entrance to the ear canal (i.e., at E), by subtracting the signal input (e.g., communication signal) from the error signal, and filtering the reference signal entering the LMS adapter. The signal input (communication signal) is preferably removed from the signal at microphone E by an error path model (model S—E) as shown in the diagram to improve convergence of the algorithm generating the adaptive filter component values. The device can compensate for changes in the position of the headphone or headset on the head by determining representations for filters S-R and S-E under prescribed circumstances, such as when the device is donned or at set time intervals, or during ongoing operation. Such devices for measuring or modeling the error path transfer function and the reference path transfer function may be separate from, be connected to, or be part of the devices used for active control of unwanted acoustic noise. The devices may involve a signal input and two signal outputs as shown in FIG. 3. The signal generation device that provides the signal input may produce sound that is uncorrelated with the unwanted acoustic noise. The signal input may consist of a swept pure tone, pseudo-random noise, including a multiple length sequence (MLS), or the communication signal, including speech, or a combination of such signals. The test signal may be constructed within the communication signal in such a way as to be masked, that is, inaudible to the user. A calculation device, such as a digital controller or DSP, produces an estimate of the reference path transfer function and the error path transfer function from the signal input and signal outputs 1 and 2, respectively. The calculation device may include an algorithm to truncate the estimated reference and error path transfer functions or synthesize in part or in whole the transfer functions from a combination of previously determined values.

The adjusted estimated reference path transfer function and the adjusted estimated error path transfer function are intended to be less sensitive to error associated with a single determination and more robust to changes in position of the ear cover. The device may employ multi-rate processing of signals to reduce the time delay of data acquisition by the reference and/or error microphones, and/or reduce the number of filter coefficients required to encompass the frequency bands of the unwanted acoustic noise. The control system shown may be combined with communication channel processing such as shown in FIGS. 2, 3 and 4.

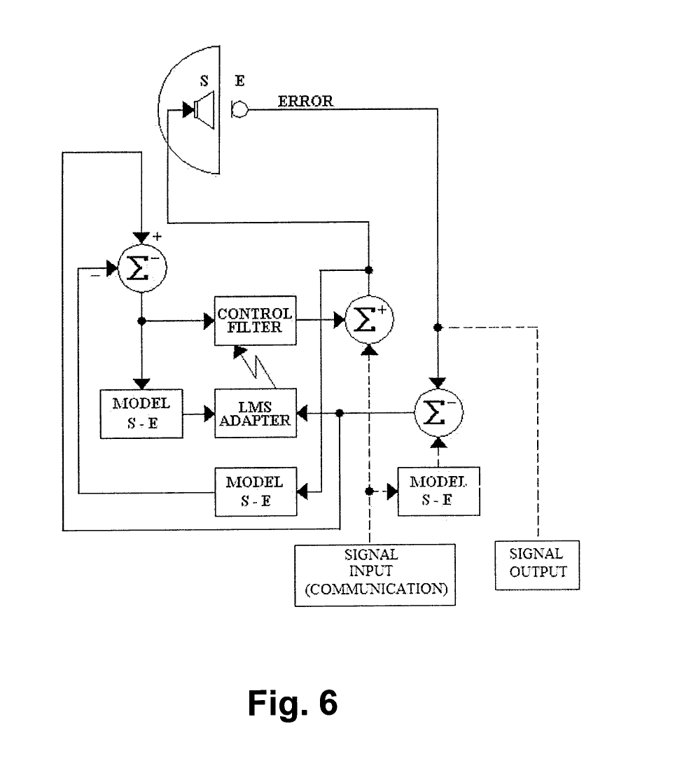

FIG. 6 is a block diagram illustrating another preferred embodiment of the present disclosure. This device is shown as an ear cover that does not involve an air seal around the ear, but could equally be constructed to fit within the ear as an earbud or earphone. In this embodiment the unwanted acoustic noise at the secondary source or earphone is reduced. This is achieved by using an adaptive feedback control system in which the error microphone, E, is mounted on, or close to, the earphone. In the version shown, the control system minimizes the environmental noise at the earphone, S, by subtracting the communication signal (i.e., the input signal) from the error signal, and feeding back the error signal to the input of the LMS adapter after removing the component at the error microphone produced by the secondary source, S (which involves filtering by the model S-E as shown in the diagram). The feedback controller is drawn with the equivalent feedforward structure to show the similarities and differences to the embodiment described by FIG. 5. The device can compensate for changes in the position of the ear cover on the head by determining representations for filter S-E under prescribed circumstances, such as when the device is donned or at set time intervals, or during ongoing operation. Such device for measuring or modeling the error path transfer function may be separate from, be connected to, or be part of the system for active control of unwanted acoustic noise as has been described above. The device may involve a signal input and signal output as shown in FIG. 6.

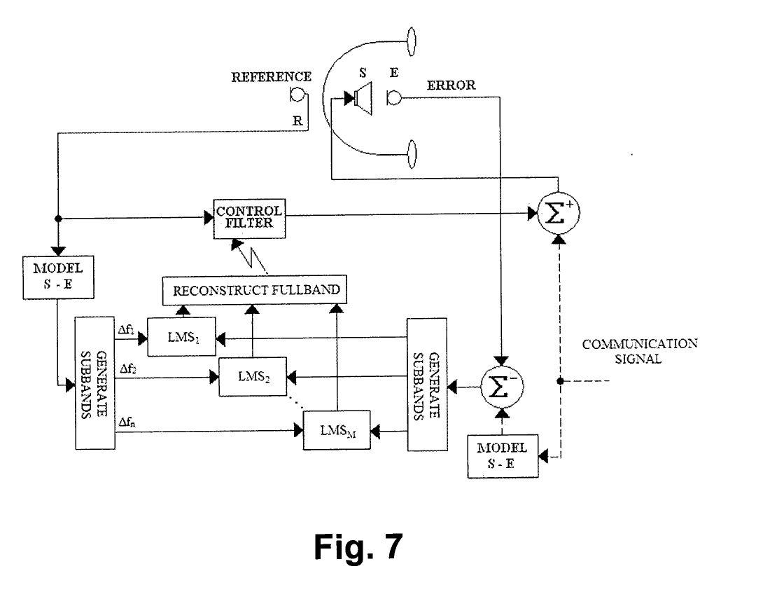

FIG. 7 is a block diagram of yet another preferred embodiment of the present disclosure, which conceptually builds on the prior art shown in FIG. 1B. The device is shown as an ear cover that includes an air seal around the ear but could equally be constructed to fit within the ear as an earplug. A simplified block diagram is shown. The device consists of a feedforward subband active noise control system, shown to the left of the diagram, with interconnections drawn as continuous lines, and a communication signal input, shown to the right, with interconnections drawn as dashed lines. Each of the n frequency subbands, Δf₁, Δf₂, . . . Δfₙ, form independent, adaptive, digital active noise controllers that operate in the time or frequency domain. The output of the control system and the communication signal are summed (indicated by Σ⁺) and fed to the secondary source or earphone, S. The SPL at E may be monitored to ensure it is within an acceptable range for hearing conservation, such as by the methods described above. The communication signal is preferably removed from the signal at microphone E by an error path model (model S-E) as shown in the diagram to improve convergence of the algorithm generating the adaptive filter component values, such as the LMS algorithm. The algorithm may include magnitude or power normalization, leakage or otherwise restrict filter adaptation at small or large sound pressures to improve the stability of adaptation and/or extend the range of sound pressures that can be successfully controlled.

The method and device for measuring or modeling the error path transfer function may be separate from, be connected to, or be part of the devices for active control of unwanted acoustic noise as has been described above. The device may involve a signal input and signal output as shown in FIG. 6. The device may employ multi-rate processing of signals to reduce the time delay of data acquisition by the reference and/or error microphones, and/or reduce the number of filter coefficients required to encompass the frequency bands of the unwanted acoustic noise. In a preferred embodiment, the sampling frequency for data acquisition may be more than ten times the frequency employed for subband generation and reconstruction.

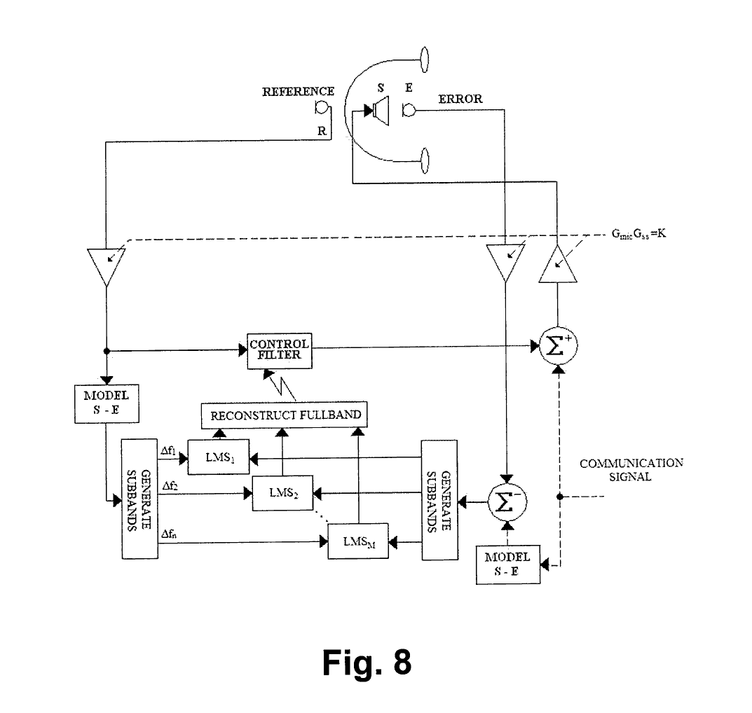

FIG. 8 is a block diagram that illustrates another preferred embodiment of the present disclosure, which is a development of the device shown in FIG. 7. The device is shown as an ear cover that includes an air seal around the ear but could equally be constructed to fit within the ear as an earplug. A simplified block diagram is shown. The device consists of the feedforward subband active noise control system, shown to the left of the diagram, with interconnections drawn as continuous lines, and the communication signal input, shown to the right, with interconnections drawn as dashed lines, as described above. In addition, the device is optimized to operate over an extended range of SPLs sensed by the reference and error microphones. This is achieved by adjusting the gains of the paths of the reference signal, or signals if there is more than one reference microphone, the control signal, or signals if there is more than one secondary source for reproducing sound at the output of the control system, and the error signal, or signals if there is more than one error microphone, so that the error path transfer function, or functions if there are more than one earphone and/or error microphone, remain unchanged. The gain blocks required are shown by the triangles in FIG. 8, and are interconnected as indicated by the long dashed lines. In one implementation, the adjustable components of the gains of the reference (G_{mic}), error (G_{mic}) and secondary source (Gₛₛ) paths are related by the equation: G_{mic}×Gₛₛ=K, where K is a numerical constant.

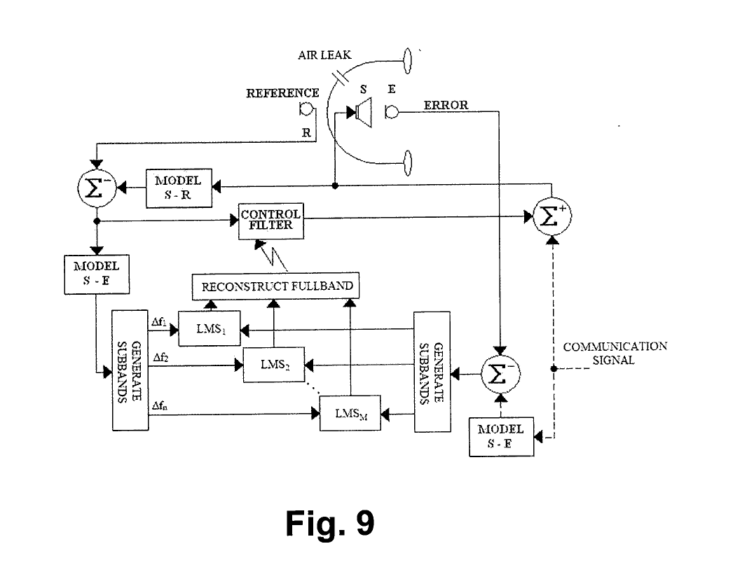

FIG. 9 is a block diagram illustrating still another preferred embodiment of the present disclosure, which is also a development of the device in FIG. 7. The device is shown as an ear cover but could equally be constructed to fit within the ear as an earplug. A simplified block diagram is shown. The device consists of the feedforward subband active noise control system, shown to the left of the diagram, with interconnections drawn as continuous lines, and the communication signal input, shown to the right, with interconnections drawn as dashed lines, as described above. In addition, the device is optimized to operate when the seal between the ear cover and head is incomplete or otherwise when there is an air leak permitting sound from the secondary source to feed back to the reference microphone, or microphones. Such an air leak may result from, for example, improper fitting of the device on the head, or from ventilation holes provided to reduce perspiration under the ear cover and so improve comfort. We have shown that an air leak effectively reduces the passive attenuation of a circumaural headset or hearing protector in a restricted range of frequencies that are within the operational range of the subband active noise control system. In such circumstances, the frequency ranges of the lowest subbands, such as Δf₁, and/or Δf₂, may be chosen to compensate for the loss of attenuation arising from the air leak. Before entering the control system the output from the earphone S is removed from the reference signal. To achieve this, the transfer function from the secondary source output to the reference microphone is modeled, shown as “model S-R,” and subtracted from the reference signal. The method and devices for measuring or modeling the reference path transfer function and error path transfer function may be separate from, be connected to, or be part of the device for active control of unwanted acoustic noise, as has been described above. The device may involve a signal input and signal outputs as shown in FIG. 5.

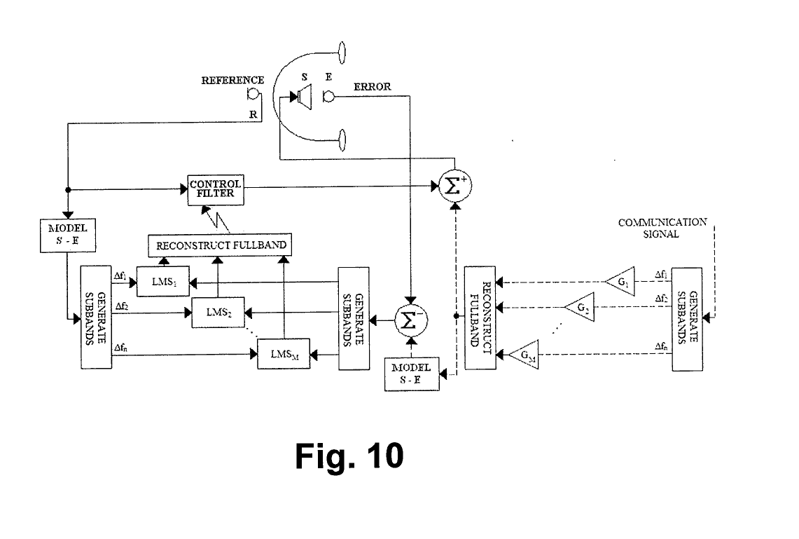

FIG. 10 is a block diagram illustrating another preferred embodiment of the present disclosure. Again, the device is shown as an ear cover that includes an air seal around the ear, but could equally be constructed to fit within the ear. A simplified block diagram is shown. The device can be separated conceptually into two parts: a feedforward subband active noise control system, shown to the left of the diagram and described above, with interconnections drawn as continuous lines, and a communication signal processor, shown to the right and described above, with interconnections drawn as dashed lines. Each of the n frequency bands, Δf₁, Δf₂, . . . Δfₙ, form independent, adaptive, digital active controllers, and in this embodiment, the frequency bands employed to control the unwanted acoustic noise are identical to those employed for processing the gain of the communication signal. Although each subsystem may operate at the same sampling frequency, the fidelity of sound reproduction by the communication channel often requires a higher sampling frequency than that required for active noise control. In such circumstances there may be benefit to employing multi-rate processing to reduce the computational complexity of the subband implementation. Hence, not all subbands may involve active noise control. The device may also employ multi-rate processing of signals to reduce the time delay of data acquisition by the reference and/or error microphones, and/or reduce the number of filter coefficients required to encompass the frequency bands of the unwanted acoustic noise. The outputs of the two subsystems are summed (indicated by Σ⁺) and fed to the secondary source or earphone, S. The SPL at E is monitored to ensure it is within an acceptable range for hearing conservation as described above (not shown in FIG. 10). The power of the communication signal is determined before amplification within each subband, and after amplification over the full bandwidth, to ensure that appropriate gain has been introduced and the SPL at the ear remains within the acceptable range for hearing conservation.

The communication signal may be removed from the signal at microphone E by an error path model (model S-E) so that the noise power can be measured in each subband and appropriate communication or speech S/N ratios established for each subband. For improved speech intelligibility the speech S/N ratios may differ for different frequency subbands, and be related to a prescribed speech intelligibility metric, such as the Speech Transmission Index or the Speech Intelligibility Index. The individual subband gains, which may differ substantially, may then be further processed to reduce the artificiality of sounds. The method and device for measuring or modeling the error path transfer function may be separate from, be connected to, or be part of the device for active control of unwanted acoustic noise as has been described above. The device may involve a signal input and signal output as shown in FIG. 6.

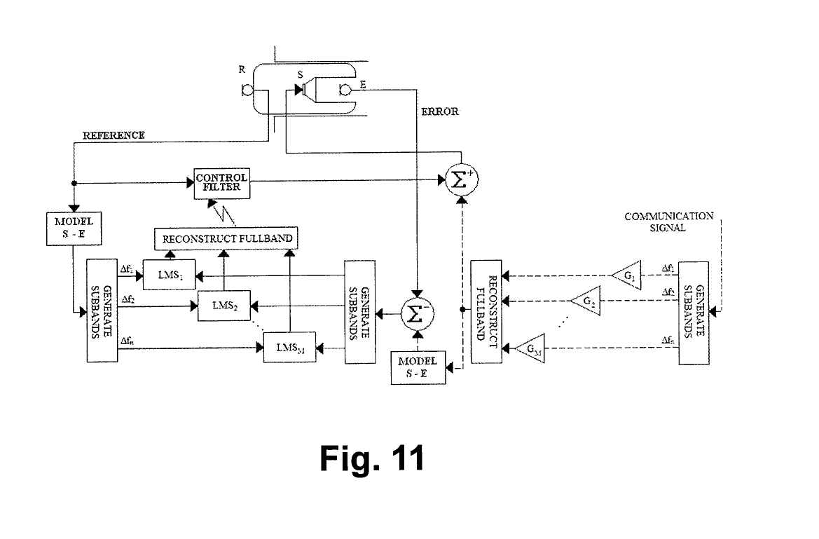

FIG. 11 is a block diagram that illustrates another preferred embodiment of the present disclosure, in which the mechanical and electro-acoustic components of the device form an earplug rather than the ear cover shown in FIG. 10. In this diagram, the earplug and ear canal are shown in cross section, with the ear canal extending to the right hand side of the page. In other respects, the embodiment is equivalent to that described in FIG. 10. The device may be combined with an ear cover or helmet to provide double protection (not shown in the diagram). This alternate configuration may be desired for devices to be used in intense noise environments.

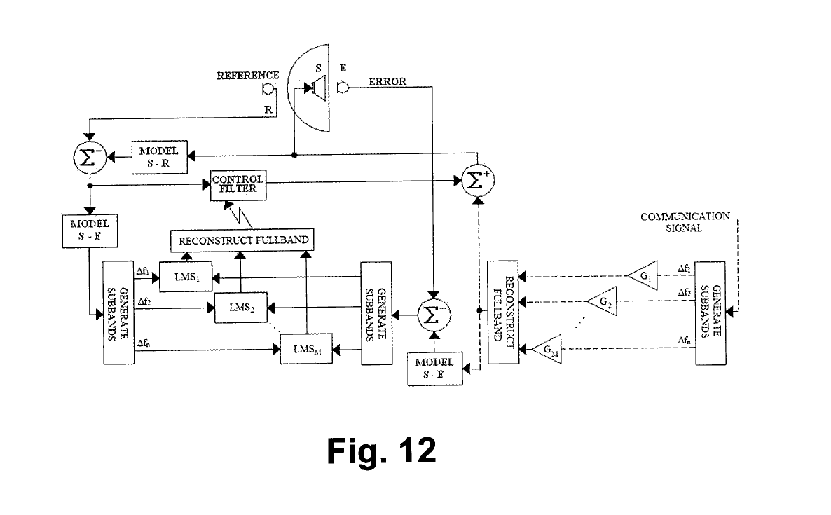

FIG. 12 is a block diagram that illustrates another preferred embodiment of the present disclosure, in which the device is an ear cover that does not involve an air seal around the ear rather than the ear cover or earplug shown in FIGS. 10 and 11. In this embodiment, the control system minimizes the environmental noise at the earphone, S, by subtracting the communication signal from the error signal (dashed lines), and removing the component at the reference microphone produced by the secondary source or earphone, S, by filtering the signal feeding the earphone by the model S-R (shown by continuous lines in the diagram). The method and device for measuring or modeling the reference path transfer function and error path transfer function may be separate from, be connected to, or be part of the device for active control of unwanted acoustic noise as has been described above. The device may involve a signal input and signal outputs as shown in FIG. 5.

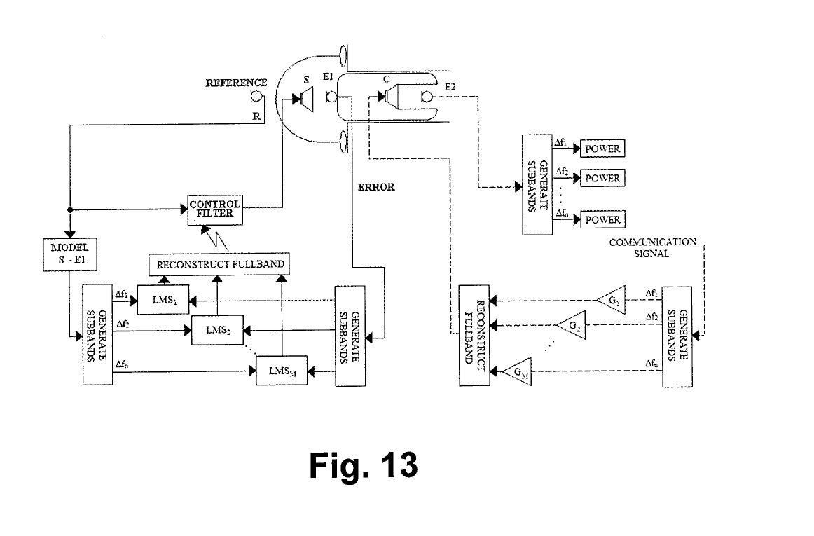

FIG. 13 is a block diagram that illustrates yet another preferred embodiment of the present disclosure, in which the device consists of an ear cover that includes an air seal around the ear and an earplug configured to produce substantial attenuation of environmental noise in the ear canal. A subband active noise controller, as described in FIG. 7, is applied to the ear cover and combined with a subband communication controller, as described by FIGS. 2 to 4, applied to the earplug. In this embodiment, the frequency bands employed to control the unwanted noise may be identical to those employed for processing the gains and S/N ratios of the communication signal subbands. For improved speech intelligibility the speech S/N ratios may differ for different frequency subbands, and be related to a prescribed speech intelligibility metric, such as the Speech Transmission Index or the Speech Intelligibility Index as described above. The individual subband gains, which may differ substantially, may then be further processed to reduce the artificiality of sounds. The combination provides double protection of the user from environmental noise, and is a preferred embodiment for high noise environments.

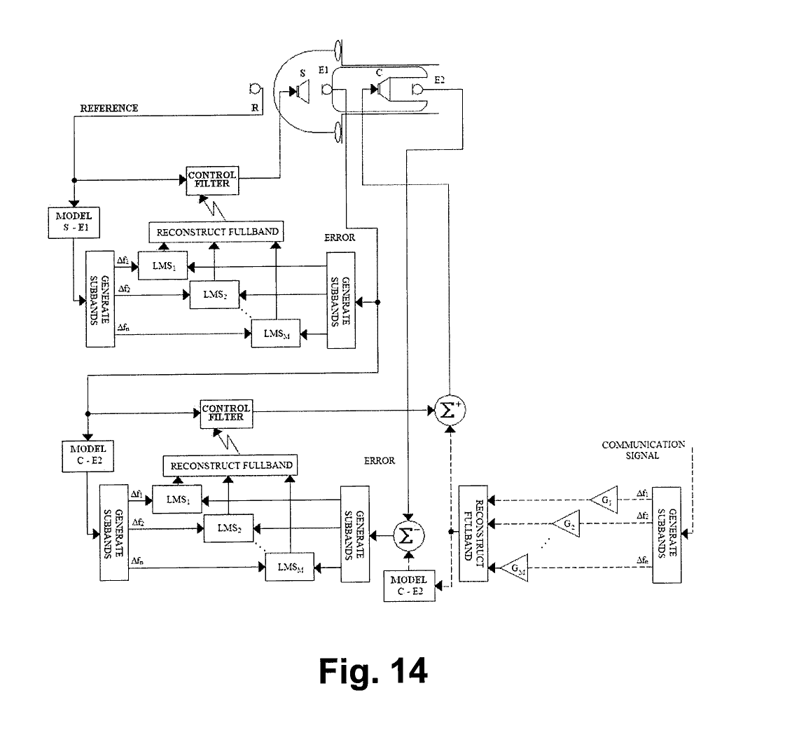

FIG. 14 is a block diagram illustrating still another preferred embodiment of the present disclosure, in which the device consists of an ear cover that includes an air seal around the ear and an earplug configured to produce substantial attenuation of environmental noise in the ear canal. A subband active noise controller, as described by FIG. 7, is applied to the ear cover. This is followed by a second subband active noise controller combined with a subband communication controller applied to the earplug, as described by FIG. 11. For the earplug control systems the frequency subbands employed to control the unwanted noise may be identical to those employed for processing the gains and speech S/N ratios of the communication signal. For improved speech intelligibility the speech S/N ratios may differ for different frequency subbands of the earplug control systems, and be related to a prescribed speech intelligibility metric, such as the Speech Transmission Index or the Speech Intelligibility Index as described above. The individual subband gains, which may differ substantially, may then be further processed to reduce the artificiality of sounds. The frequency subbands of the control system within the ear cover may be different from those employed in the earplug. The method and device for measuring or modeling the error path transfer functions of the two systems active noise control systems may be separate from, be connected to, or be part of the device for active control of unwanted acoustic noise as has been described above. The combination provides double protection of the user from environmental noise and is a preferred embodiment for high noise environments.

### EXPERIMENTAL DATA

Integrating Speech Enhancement with Active Hearing Protectors to Improve Communication

Some workers forego hearing protection devices in favor of improved communication with coworkers. By integrating active noise reduction (ANR) to reduce environmental noise levels and knowledge of psychoacoustical speech intelligibility models, such as the Speech Transmission Index (STI), developed for objective evaluation of communication systems, a system has been developed (in simulation) that adaptively adjusts the characteristics of a communication channel to improve speech intelligibility without exceeding hearing damage thresholds.

Materials and Methods: An Active Noise Reduction (ANR) Hearing Protection Device (HPD) combines the mid-to-high frequency attenuation of a passive ear cup with the low frequency attenuation of an active system to better limit harmful environmental noise. To improve speech communication, a delayless feedforward subband ANR structure was modified to measure the power of noise under the ear cup. Using the more common Filtered-X Least Mean Squares (FxLMS) ANR method, only the power over the entire bandwidth is available. The subband ANR structure allows monitoring of noise powers in a series of frequency bands, and thus enables a better distribution of communication signal power. The original communication signal is then analyzed using an identical subband structure and the gain in each band is adapted to meet a desired S/N ratio target without exceeding a maximum sound pressure limit.

Results: Table 1 provides the results of two experiments evaluating the performance characteristics of three HPD systems: a passive and an FxLMS system with a fixed communication channel gain, and the subband system with an adaptive gain.

TABLE 1
Comparison of the Noise (N) and Noise +
Speech (N + S) power, in dBₛₚᵢ, and STI values from
Passive, FxLMS, and Subband HPD systems

| | 12 dB target SNR | | | 80 dBₛₚᵢ max power | | |
|---|---|---|---|---|---|---|
| | N | N + S | STI | N | N + S | STI |
| Passive | 79.4 | 80.0 | 0.2 | — | — | — |
| FxLMS | 59.7 | 60.3 | 0.2 | 73.3 | 85.1 | 0.9 |
| Subband | 60.8 | 72.3 | 0.7 | 74.4 | 80.8 | 0.6 |

To demonstrate the ability of the subband system to meet a desired S/N ratio target, the environmental noise level was set to 80 dBₛₚₗ for the passive system and the initial communication channel gain was set to provide an STI value of 0.2.

The subband system properly identifies the reduced noise power at the ear provided by ANR and increases the communication channel gain to meet a target S/R ratio of 12 dB while the FxLMS system keeps the inadequate gain levels. The improvement in STI from 0.2 to 0.7 corresponds to an improvement in word recognition for critical communication from 50% to 95% (Modified Rhyme Test).

When testing the maximum power limit of the subband system, the environmental noise level was set to 73 dBₛₚₗ for the FxLMS system and the communication channel gain was set to provide an S/N ratio of 12 dB, so that the combined Noise plus Speech (N+S) exceeded the maximum power limit of 80 dBₛₚₗ. The subband system identifies that the power at the ear exceeds 80 dBₛₚₗ and thus reduces the communication channel gain to minimize potential damage to hearing. The reduction in the STI value to 0.6 results in an acceptable decrease in word recognition to 90%.

Conclusions: The modified subband system demonstrates the ability to adjust communication characteristics and improve speech intelligibility without exceeding hearing damage thresholds. Improvements in STI values show a benefit for critical communication in high noise environments.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variations that fall within the scope of the disclosure.

What is claimed is:

1. A method for enhancing audibility, localization and/or speech intelligibility of communication devices worn on the head or in the ear for a user with normal hearing or hearing loss, comprising:
providing active control of sound and of unwanted acoustic noise,
wherein the active control is achieved by a feature selected from the group consisting of: active feedforward control of sound and of unwanted acoustic noise; active feedback control of sound and of unwanted acoustic noise; active control of the amplitude and/or frequency of a desired sound and/or unwanted acoustic noise, and any combinations thereof.

2. The method according to claim 1, wherein said active control of amplitude further comprises amplitude compression.

3. The method according to claim 1, wherein said active control of frequency further comprises frequency selection.

4. The method according to claim 1, further comprising:
multi-rate processing of a signal, said multi-rate processing reducing a time delay of data acquisition and/or reducing the number of filter coefficients required to encompass the frequency bands of said sound or said unwanted acoustic noise.

5. The method according to claim 1, further comprising fullband processing of said desired sounds and/or said unwanted acoustic noise.

6. The method according to claim 1, further comprising subband processing of said desired sounds and/or said unwanted acoustic noise.

7. The method according to claim 6, wherein said subband processing is delayless subband processing.

8. The method according to claim 1, wherein said enhancing of localization of said desired sounds further comprises the step selected from the group consisting of: binaural processing of sounds sensed and reproduced at both ears of said user; employing multiple microphones on an ear cover, hard hat, or helmet; frequency shaping to simulate the acoustic characteristics of the ear; and shaping the exterior of an ear cover to introduce frequency-selective characteristics of the structures of the external ear; and any combinations thereof.

9. The method according to claim 1, wherein said sound is one or more sounds that is generated from one or more sources.

10. The method according to claim 1, wherein said enhancing of audibility, localization and/or intelligibility of speech for said user further comprises the feature selected from the group consisting of: employing frequency-dependent amplification determined by the audiometric hearing thresholds of said user; employing frequency-dependent amplification and/or sound pressure-dependent amplification; employing one or more directional microphones and/or an array of microphones; maintaining sound levels at the ear of said user within preset limits to protect hearing; maintaining sound-to-noise ratio and/or speech sound-to-noise ratio at the ear of said user within preset limits; and any combinations thereof.

11. The method according to claim 1, further comprising a step selected from the group consisting of: measuring an error path transfer function of a system, simulating an error path transfer function, truncating an error path transfer function, and any combinations thereof, for controlling said sound and/or said unwanted acoustic noise.

12. The method according to claim 1, further comprising sampling said desired sound at a different sampling frequency than said unwanted acoustic noise.

13. The method according to claim 12, wherein said desired sound is sampled at a higher frequency than said unwanted acoustic noise.

14. The method according to claim 1, further comprising restricting filter adaptation at small or large signal magnitudes.

15. The method according to claim 1, further comprising varying the gains of the paths of the reference signal, control signal, and error signal, such that an error path transfer function response remains unchanged.

16. The method according to claim 1, further comprising sensing a sound pressure at the eardrum by positioning a microphone within the concha at the entrance to the ear canal.

17. The method according to claim 11, further comprising employing an adaptive filter, to compensate for changes in the error path transfer function.

18. The method according to claim 17, wherein the adaptive filter is an adaptive subband filter.

19. The method according to claim 1, further comprising employing an adaptive filter or adaptive subband filter to compensate for an air leak in a seal between said communication device and the skin around the ear of said user.

20. The method according to claim 1, further comprising employing an adaptive filter or adaptive subband filter to compensate for an air leak resulting from ventilation holes, thereby enhancing user comfort.

21. The method according to claim 1, further comprising increasing the amplification of the communication signal, thereby increasing the signal-to-noise ratio.

22. The method according to claim 1, said enhancing of localization of sounds further comprising constructing a sound field at the ear that mimics directional information of the sound source.

23. The method according to claim 1, further comprising combining one or more ear cover, hard hat, helmet and earplug for double protection of said user from said unwanted noise.

24. A communication device worn on the head or in the ear of a user for enhancing audibility, localization and/or speech intelligibility of sounds, comprising:
a first electro-acoustic device, wherein said first electro-acoustic device generates a first sound to said user;
a second electro-acoustic device, wherein said second electro-acoustic device senses a second sound for said user, and wherein said first sound is different from said second sound; and
a controller, wherein said controller is selected from the group consisting of an analog controller and a digital controller,
wherein the controller provides active control of sound and of unwanted acoustic noise, and wherein the active control is achieved by a feature selected from the group consisting of: active feedforward, active feedback, active control of the amplitude and/or frequency of a desired sound and/or acoustic noise, and any combinations thereof.

25. The communication device according to claim 24, wherein said first electro-acoustic device is an earphone.

26. The communication device according to claim 24, wherein said second electro-acoustic device is a microphone.

27. The communication device according to claim 24, wherein said controller is selected from the group consisting of: amplifier, digital signal processor (DSP), and combinations thereof.

28. The communication device according to claim 24, wherein said controller comprises a filter selected from the group consisting of: low-pass filter, high-pass filter, band-pass filter, and any combinations thereof.

29. The communication device according to claim 24, wherein said communication device is a structure selected from the group consisting of: ear cover, earplug, earbud, hard hat that does not cover the ear, helmet that does not cover the ear, and any combinations thereof.

30. The communication device according to claim 29, wherein said communication device is built into the structure.

31. The communication device according to claim 24, wherein the communication device is contoured to the head or ear canal to equalize contact pressure and to enhance user comfort.

32. The communication device according to claim 24, wherein the communication device has air ventilation paths to the ear and/or within the ear canal to enhance user comfort.

33. The communication device according to claim 24, wherein the communication device enhances audibility, localization and/or speech intelligibility of communication devices worn on the head or in the ear for a user with normal hearing or hearing loss by providing active control of sound and of unwanted acoustic noise,
wherein the active control is achieved by a feature selected from the group consisting of: active feedforward control of sound and of unwanted acoustic noise; active feedback control of sound and of unwanted acoustic noise; active control of the amplitude and/or frequency of a desired sound and/or unwanted acoustic noise, and any combinations thereof.
